(19) United States
(12) Patent Application Publication
(10) Pub. No.: US 2013/0343699 A1
(43) Pub. Date: Dec. 26, 2013

(54) WAVELENGTH DIVISION MULTIPLEXER/DEMULTIPLEXER WITH REDUCED PHYSICAL DIMENSION

(71) Applicants: Near Margalit, Chatsworth, CA (US); Yu Heng Jan, Hsinchu (TW); E. Min Chou, Hsinchu (TW); Yung Cheng Chang, Hsinchu (TW)

(72) Inventors: Near Margalit, Chatsworth, CA (US); Yu Heng Jan, Hsinchu (TW); E. Min Chou, Hsinchu (TW); Yung Cheng Chang, Hsinchu (TW)

(21) Appl. No.: 13/528,107

(22) Filed: Jun. 20, 2012

(51) Int. Cl. G02B 6/35

(52) U.S. Cl. 385/18

(57) ABSTRACT

A wavelength division multiplexer/demultiplexer includes an optical block having a plurality of protrusions positioned at a first side, wherein at least one of the protrusions has a first inclined plane configured to reflect a light propagating in the optical block to a second inclined plane of the protrusion. Another wavelength division multiplexer/demultiplexer includes an optical block having a first side, a plurality of depressions indented from the first side, wherein at least one of the depressions has a first inclined plane configured to reflect a light to a second side and a second inclined plane configured to reflect the light from the second side.

### BACKGROUND

1. Technical Field

The present disclosure relates to a wavelength division multiplexer/demultiplexer with reduced physical dimension, and more particularly, to a wavelength division multiplexer/demultiplexer having inclined planes to reflect the light propagating therein.

2. Description of Related Arts

While fiber-optic cable is finding widespread use for data transmission and other telecommunication applications, the relatively high cost of newly installed fiber-optic cable presents a barrier to increased carrying capacity. Wavelength division multiplexing (WDM) allows multiple different wavelengths to be carried over a common fiber-optic waveguide. Presently preferred wavelength bands for fiber-optic transmission media include those centered at 1.3 micrometers and 1.55 micrometers. Wavelength division demultiplexing can separate this bandwidth into multiple channels. Dividing bandwidth into multiple discreet channels, such as 4, 8, 16 or even as many as 32 channels, through a technique referred to as dense channel wavelength division multiplexing (DWDM), is a relatively lower cost method of substantially increasing telecommunication capacity using existing fiber-optic transmission lines.

Techniques and devices are required, however, for multiplexing the different discreet carrier wavelengths. That is, the individual optical signals must be combined onto a common fiber-optic line or other optical waveguide and then later separated again into the individual signals or channels at the opposite end or other point along the fiber-optic cable. Thus, the ability to effectively combine and then separate individual wavelengths (or wavelength sub-ranges) from a broad spectral source is of growing importance to the fiber-optic telecommunications field and other fields employing optical instruments.

FIG. 1 is a schematic view showing a conventional zigzag wavelength division multiplexer/demultiplexer 20. The conventional zigzag wavelength division multiplexer/demultiplexer 20 includes an optical block 10 having a first surface 11 and a second surface 13, a reflector 15 positioned on the first surface 11, and a plurality of filters 17A-17D separately positioned on the second surface 13.

When the wavelength division multiplexer/demultiplexer 20 is used in a demultiplexing system, a light 19 is coupled into the optical block 10 at a slight angle through the second surface 13 of the optical block 10. The light 19 propagates within the optical block 10 to the first surface 11, where the reflector 15 reflects the light 19 to the filter 17A at the second surface 13. The filter 17A is configured in such a way that a beam 19A with a predetermined wavelength λ1 of the light 19 can pass through, while the other beams 19B-19D of the light 19 are reflected to the reflector 15 at the first surface 11. The reflected light 19 continuously propagates in the optical block 10 in a zigzag manner between the reflector 15 and the filters 17B-17D, wherein the beam 19B with a predetermined wavelength λ2 passes through the filter 17B, the beam 19C with a predetermined wavelength λ3 passes through the filter 17C, and the beam 19D with a predetermined wavelength λ4 passes through the filter 17D.

The size of the conventional zigzag wavelength division multiplexer/demultiplexer 20 cannot be decreased since the reflection angle θ and the position of the filters determine the zigzag path of the light 19 propagating in the optical block 10 and the size of the conventional zigzag wavelength division multiplexer/demultiplexer 20. In addition, to fit the required reflection angle θ and size requirement, the filters 17A-17D used in the conventional zigzag wavelength division multiplexer/demultiplexer 20 must be compact in size or array type.

### SUMMARY

One aspect of the present disclosure provides a wavelength division multiplexer/demultiplexer having inclined planes to reflect the light propagating therein.

A wavelength division multiplexer/demultiplexer according to this aspect of the present disclosure comprises an optical block having a plurality of protrusions positioned at a first side, and at least one of the protrusions having a first inclined plane configured to reflect a light propagating in the optical block to a second inclined plane of the protrusion.

A wavelength division multiplexer/demultiplexer according to another aspect of the present disclosure comprises an optical block having a first side, a plurality of depressions indented from the first side, and at least one of the depressions having a first inclined plane configured to reflect a light to a second side of the optical block and a second inclined plane configured to reflect the light from the second side.

The size of the conventional zigzag wavelength division multiplexer/demultiplexer in FIG. 1 cannot be decreased when the reflection angle θ and the position of the filters determine the zigzag path of the light propagating in the optical block. In contrast, the wavelength division multiplexer/demultiplexer according to one embodiment of the present disclosure uses the first inclined plane and the second inclined plane to reflect the light propagating in the optical block so as to change the optical path of the light. As a result, the height of the wavelength division multiplexer/demultiplexer can be decreased, and the size can be decreased correspondingly.

In the conventional zigzag wavelength division multiplexer/demultiplexer, to fit the required reflection angle θ and size requirement, the filters must be compact in size or array type. In an exemplary embodiment of the present disclosure, the first inclined plane and the second inclined plane of the protrusions (or the depressions) are separated by different distances from one protrusion to another protrusion such that filters having different sizes or designs can be used in the wavelength division multiplexer/demultiplexer.

In a preferred embodiment of the present disclosure, the wavelength division multiplexer/demultiplexer may implement more multiplexing operations by adding extra protrusions (or depressions) laterally and corresponding filters to couple more beams into the light.

In a preferred embodiment, the channel number of the wavelength division multiplexer/demultiplexer can be further increased by adding the extra protrusions (or depressions) laterally and adding corresponding filters to implement further demultiplexing operations.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the concepts and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a schematic view showing a conventional zigzag wavelength division multiplexer/demultiplexer;

FIG. 2 illustrates a wavelength division multiplexer/demultiplexer according to one embodiment of the present disclosure;

FIG. 3 is a sectional view along the line 1-1 in FIG. 2 according to one embodiment of the present disclosure;

FIG. 4 illustrates a wavelength division multiplexer/demultiplexer according to one embodiment of the present disclosure;

FIG. 5 illustrates a wavelength division multiplexer/demultiplexer according to one embodiment of the present disclosure;

FIG. 6 illustrates a wavelength division multiplexer/demultiplexer according to one embodiment of the present disclosure;

FIG. 7 compares the size of the conventional zigzag wavelength division multiplexer/demultiplexer in FIG. 1 and the wavelength division multiplexer/demultiplexer in FIG. 3 according to one embodiment of the present disclosure; and

FIG. 8 illustrates a wavelength division multiplexer/demultiplexer for implementing the demultiplexing operation according to one embodiment of the present disclosure.

### DETAILED DESCRIPTION

The following description of the disclosure accompanies drawings, which are incorporated in and constitute a part of this specification and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to a wavelength division multiplexer/demultiplexer. In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

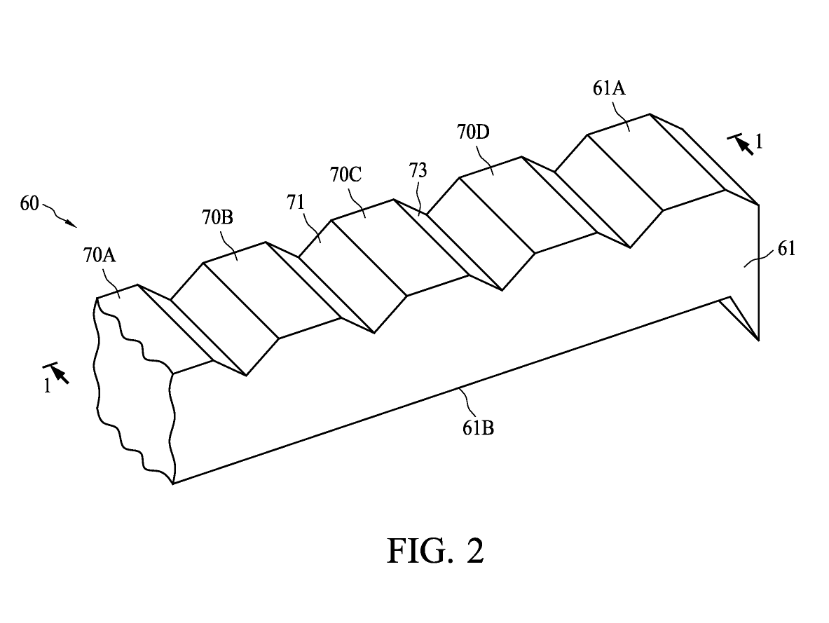

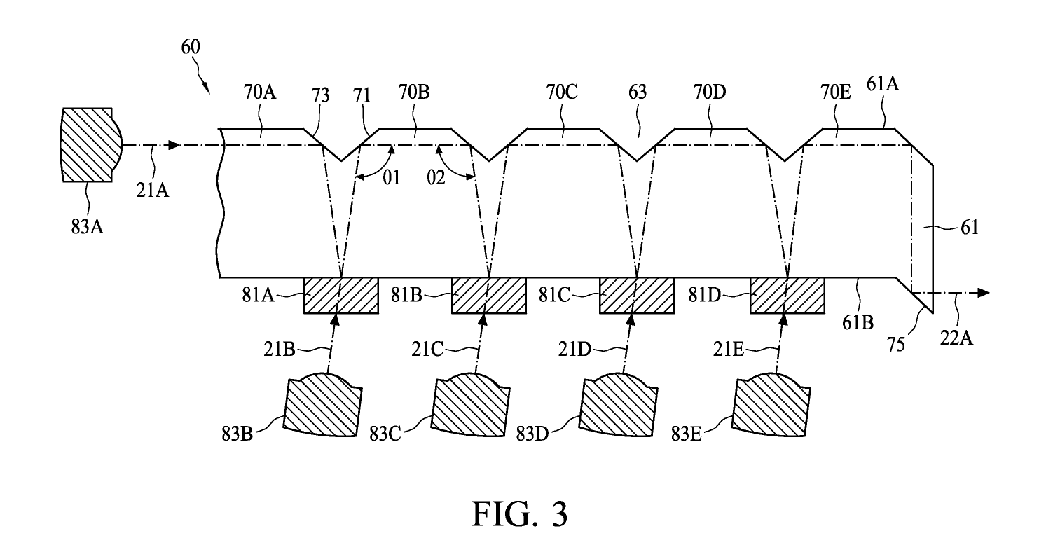

FIG. 2 illustrates a wavelength division multiplexer/demultiplexer 60 according to one embodiment of the present disclosure, and FIG. 3 is a sectional view along the sectional line 1-1 in FIG. 2. In one embodiment of the present disclosure, the wavelength division multiplexer/demultiplexer 60 comprises an optical block 61 having a first side 61A and a second side 61B, a plurality of filters 81A-81D positioned at the second side 61B of the optical block 61, and a plurality of optical devices 83A-83E such as the lens or light sources. In a preferred embodiment of the present disclosure, the optical block 61 comprises a plurality of protrusions 70A-70E positioned at the first side 61A.

In an exemplary embodiment of the present disclosure, the protrusion 70B has an inclined plane 71 configured to reflect a light 21A propagating in the optical block 61 to an inclined plane 73 of the protrusion 70B. In a preferred embodiment of the present disclosure, each of the protrusions 70B-70E has an inclined plane 71 and an inclined plane 73. In one embodiment of the present disclosure, the inclined plane 71 and the inclined plane 73 are total reflection planes. In one embodiment of the present disclosure, the protrusions 70A-70E of the optical block 61 are separated respectively by a plurality of depressions 63 indented from the surface of the optical block 61 at the first side 61A. In a preferred embodiment of the present disclosure, the depressions are V-shaped grooves between two of the protrusions 70A-70E.

In one embodiment of the present disclosure, when the wavelength division multiplexer/demultiplexer 60 is used in a multiplexing system, the light 21A with a predetermined wavelength λ1 from the optical device 83A is coupled into the optical block 61 and propagates within the optical block 61 to the inclined plane 73 of the protrusion 70A, where the light 21A is reflected to the filter 81A at the second side 61B; the filter 81A at the second side 61B then reflects the light 21A to the inclined plane 71 of the protrusion 70B adjacent to the protrusion 70A at the first side 61A. In one embodiment of the present disclosure, a light 21B with a predetermined wavelength λ2 from the optical device 83B passes through the filter 81A at the second side 61B and propagates with the light 21A within the optical block 61 to the inclined plane 71 of the protrusion 70B. As a result, the light 21A and the light 21B are combined, i.e., a multiplexing operation is implemented.

In one embodiment of the present disclosure, the combined light comprising the light 21A and the light 21B is reflected by the inclined plane 71 to the inclined plane 73 of the second protrusion 70B and continuously propagates in the optical block 61 between the protrusions 70B-70E at the first side 61A and the filters 81B-81D at the second side 61B. In an exemplary embodiment of the present disclosure, a light 21C with a predetermined wavelength λ3 from the optical device 83C passes through the filter 81B and propagates within the optical block 61 to the inclined plane 71 of the protrusion 70C at the first side 61A, a light 21D with a predetermined wavelength λ4 from the optical device 83D passes through the filter 81C and propagates within the optical block 61 to the inclined plane 71 of the protrusion 70D at the first side 61A, and a light 21E with a predetermined wavelength λ5 from the optical device 83E passes through the filter 81D and propagates within the optical block 61 to the inclined plane 71 of the protrusion 70E at the first side 61A. As a result, the lights 21A-21E are coupled into a multiplexed light 22A, i.e., several multiplexing operations are implemented in the optical block 61 to form the multiplexed light 22A.

In an exemplary embodiment of the present disclosure, the inclined plane 71 is configured to reflect the light in such a way that the light propagates along an optical path having a first included angle θ1 lager than 90 degrees at the inclined plane 71. In an exemplary embodiment of the present disclosure, the inclined plane 73 is configured to reflect the light in such a way that the light propagates along an optical path having a second included angle θ2 lager than 90 degrees at the inclined plane 73. In a preferred embodiment of the present disclosure, the inclined plane 71 and the inclined plane 73 are configured to reflect the light in such a way that the light propagates along an optical path having a trapezoid shape in the optical block 61. In a preferred embodiment of the present disclosure, the inclined plane 71 is configured to reflect the light to the inclined plane 73 in such a way that the optical path of the light between the inclined plane 71 and the inclined plane 73 is substantially in parallel to a side surface of the first side 61A. In one embodiment of the present disclosure, the optical block 61 includes an inclined plane 75 configured to output the multiplexed light 22A. In a preferred embodiment of the present disclosure, the inclined plane 75 is a total reflection plane. In an exemplary embodiment of the present disclosure, the vertical position of the inclined plane 75 can be changed such that the multiplexed light 22A is output at a vertical position between the first side 61A and the second 61B, where an external receiver is placed.

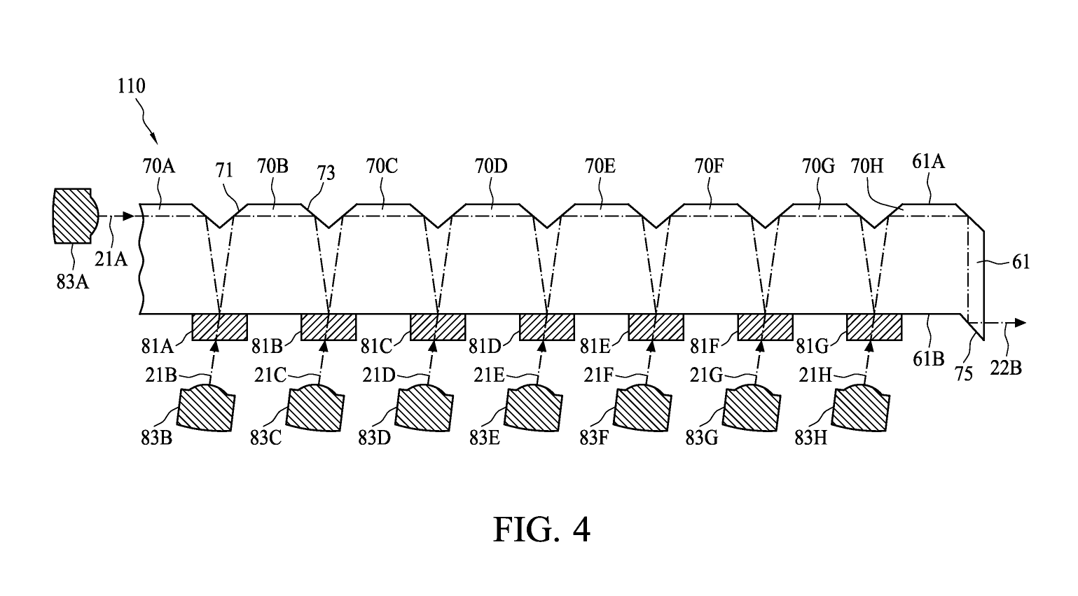

FIG. 4 illustrates a wavelength division multiplexer/demultiplexer 110 according to one embodiment of the present disclosure. Compared to the wavelength division multiplexer/demultiplexer 60 implementing five multiplexing operations in FIG. 3, the wavelength division multiplexer/demultiplexer 110 in FIG. 4 can implement eight multiplexing operations. In an exemplary embodiment of the present disclosure, the multiplexing operations of the lights 21A-21E into the multiplexed light 22B in FIG. 4 are substantially the same as that in FIG. 3. In an exemplary embodiment of the present disclosure, after the combined light being reflected by the filter 81D, more lights 21F-21H are coupled into the combined light by adding the protrusions 70E-70H laterally and adding corresponding filters 81E-81G and optical devices 83F-83H, i.e., further multiplexing operations are implemented in FIG. 4. In a preferred embodiment of the present disclosure, further multiplexing operations can be implemented by adding more protrusions laterally and corresponding filters to couple more lights into the multiplexed light.

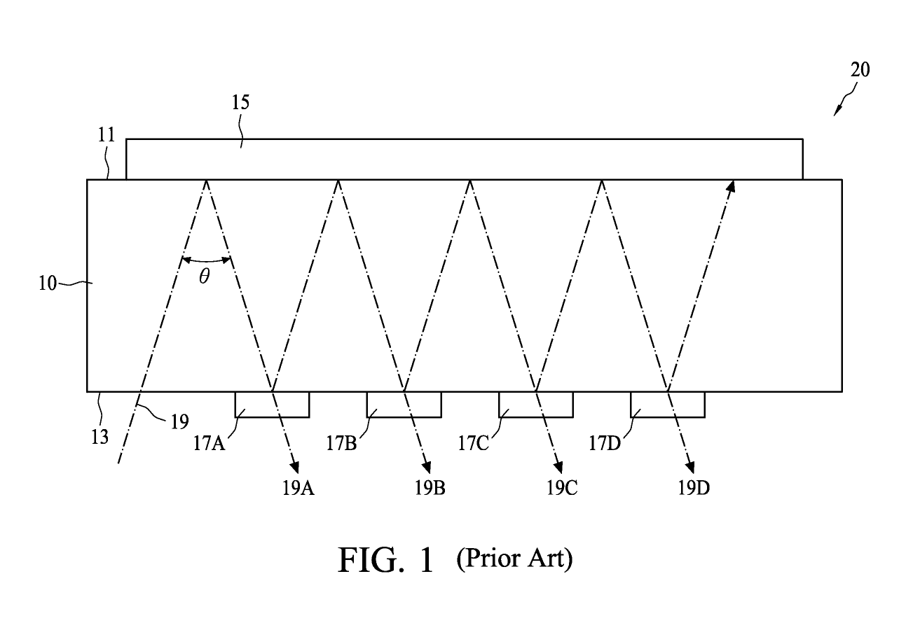

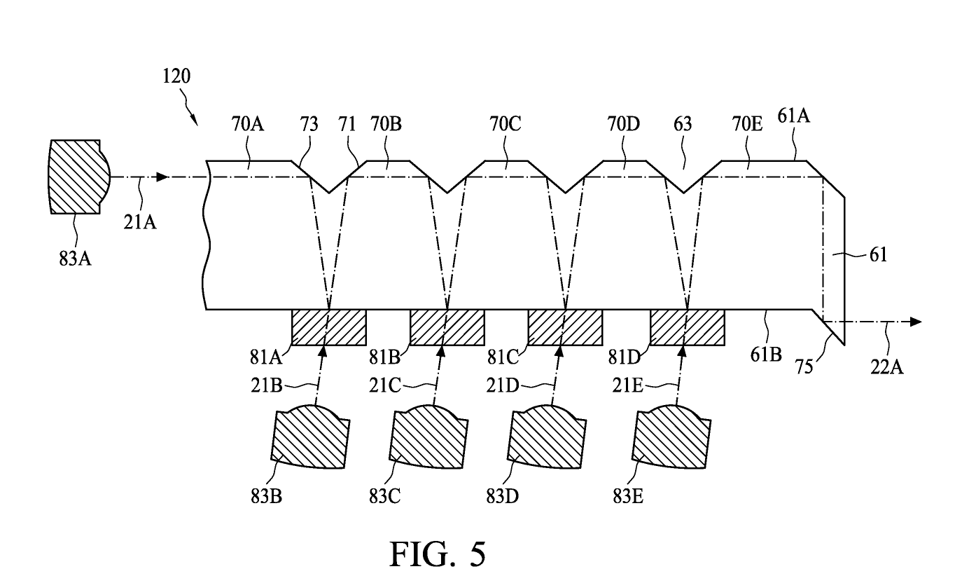

FIG. 5 illustrates a wavelength division multiplexer/demultiplexer 120 according to one embodiment of the present disclosure. Compared to the wavelength division multiplexer/demultiplexer 60 having protrusions 70A-70E of the same width in FIG. 3, the wavelength division multiplexer/demultiplexer 120 in FIG. 5 has protrusions 70A-70E of different width. In an exemplary embodiment of the present disclosure, the inclined plane 71 and the inclined plane 73 (or the depressions 63) are separated by different distances from one protrusion to another protrusion such that the filters 81A-81D in the wavelength division multiplexer/demultiplexer 120 may have different sizes or designs. In contrast, in the conventional zigzag wavelength division multiplexer/demultiplexer 20 in FIG. 1, to fit the required reflection angle θ and size requirement, the filters 17A-17D must be compact in size or array type.

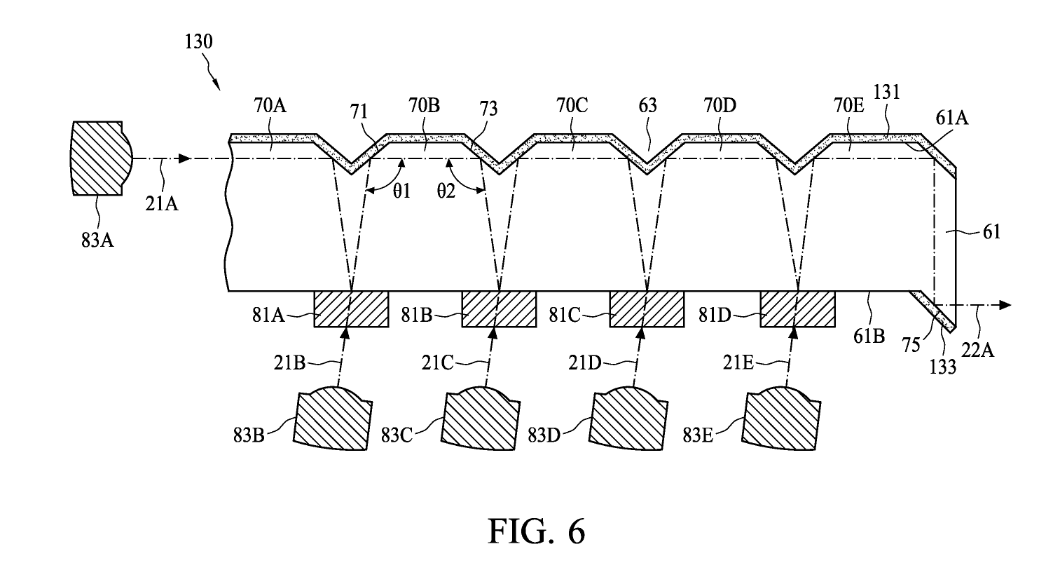

FIG. 6 illustrates a wavelength division multiplexer/demultiplexer 130 according to one embodiment of the present disclosure. Compared to the wavelength division multiplexer/demultiplexer 60 having inclined planes 71, 73, 75 of the total reflection planes in FIG. 3, the wavelength division multiplexer/demultiplexer 130 in FIG. 6 includes a reflector 131 covering the inclined plane 71 and the inclined plane 73, and a reflector 133 covering the inclined plane 75 such that it is not necessary for the inclined planes 71, 73 are to be the total reflection planes.

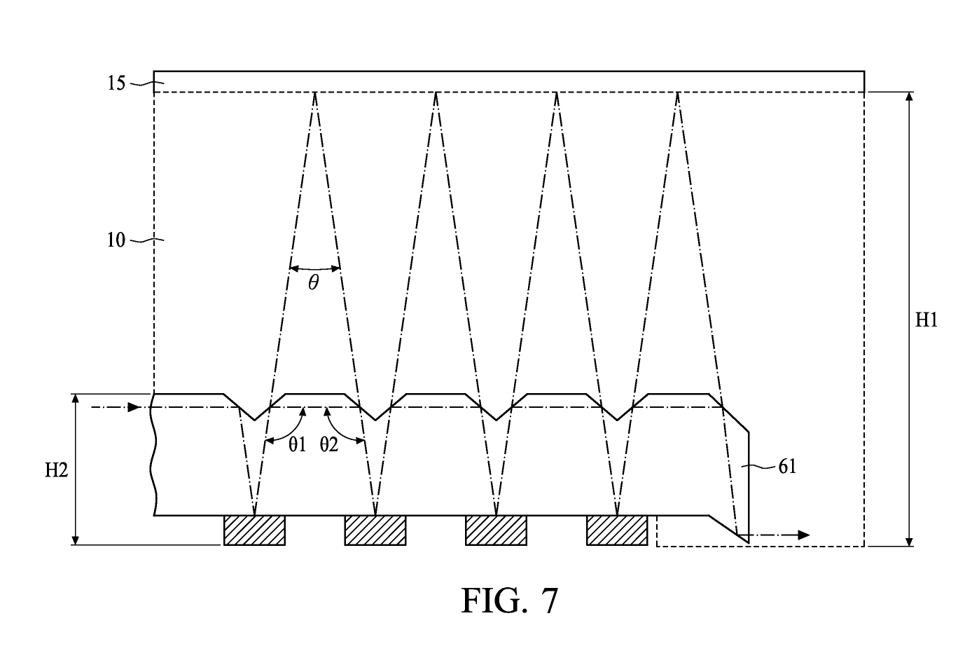

FIG. 7 compares the size of the conventional zigzag wavelength division multiplexer/demultiplexer 20 in FIG. 1 and the wavelength division multiplexer/demultiplexer 60 in FIG. 3 according to one embodiment of the present disclosure. The size of the conventional zigzag wavelength division multiplexer/demultiplexer 20 in FIG. 1 can not be decreased when the reflection angle θ and the position of the filters has determined the zigzag path of the light propagating in the optical block 10 such that the conventional zigzag wavelength division multiplexer/demultiplexer 20 has a height H1. In contrast, the wavelength division multiplexer/demultiplexer 60 in FIG. 3 according to one embodiment of the present disclosure uses the inclined planes 71, 73 to reflect the light propagating therein so as to change the optical path of the light. As a result, the height of the wavelength division multiplexer/demultiplexer can be decreased from H1 to H2, and the size can be decreased correspondingly.

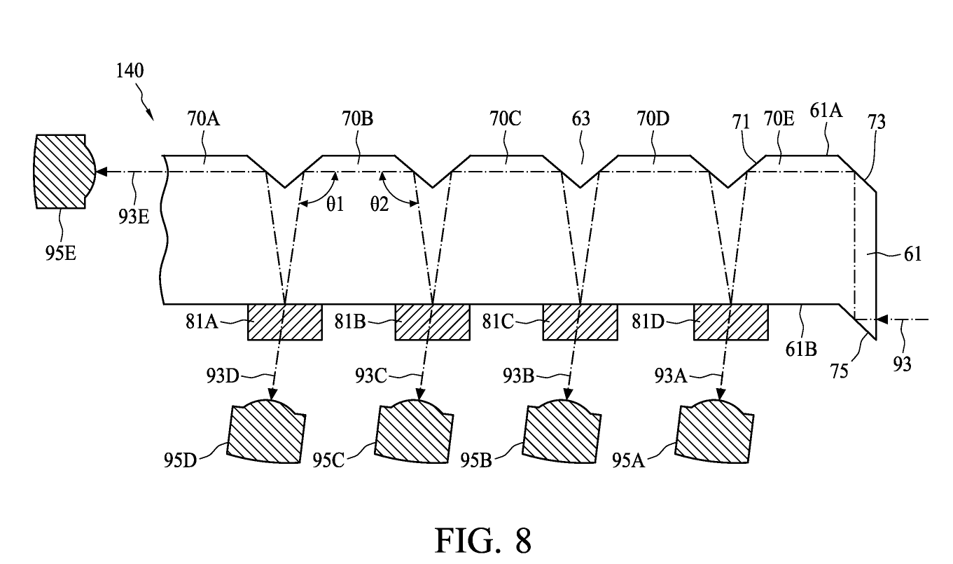

FIG. 8 illustrates a wavelength division multiplexer/demultiplexer 140 for implementing the demultiplexing operation according to one embodiment of the present disclosure. In one embodiment of the present disclosure, when the optical block 61 is used in a demultiplexing system, a light 93 is coupled into the optical block 61 through the inclined plane 75 and propagates within the optical block 61 to the inclined plane 73 of the protrusion 70E at the first side 61A. Subsequently, the light 93 is reflected to the inclined plane 71 of the protrusion 70E, which further reflects the light 93 to the filter 81D at the second side 61B, and the filter 81D then reflects the light 93 to the inclined plane 73 of the protrusion 70D adjacent to the protrusion 70E. In one embodiment of the present disclosure, the filter 81D is configured in such a way that a beam 93A of the light 93 can pass through and reach the optical device 95A, while the other beams 93B-93E of the light 93 are reflected by the filter 81D to the inclined plane 73 of the protrusion 70D adjacent to the protrusion 70E. As a result, the beam 93A is separated from the other beams 93B-93E of the light 93, i.e., a demultiplexing operation is implemented.

In one embodiment of the present disclosure, the reflected light 93 continuously propagates in the optical block 61 between the protrusions 70D-70A at the first side 61A and the filters 81C-81A at the second side 61B, wherein the beam 93B passes through the filter 81C and reaches the optical device 95B, the beam 93C passes through the filter 81B and reaches the optical device 95C, the beam 93D passes through the filter 81A and reaches the optical device 95D, and the beam 93E reaches the optical device 95E. As a result, the beams 93B-93E are separated from the light 93, i.e., further demultiplexing operations are implemented.

Comparing the wavelength division multiplexer/demultiplexer 60 for implementing the multiplexing operation in FIG. 3 with the wavelength division multiplexer/demultiplexer 140 for implementing the demultiplexing operation in FIG. 8, one has ordinary skill in the art can appreciate that the optical block 61 can be used to implement both the multiplexing operation and the demultiplexing operation, with the light propagating in the optical block 61 along opposite directions. In other words, the light propagates in the optical block 61 along a first direction as the optical block 61 is used in a multiplexing system, and the light propagates in the optical block 61 along a second direction opposite to the first direction as the optical block 61 is used in a demultiplexing system.

Although the present disclosure and its advantages have been described in detail, it should be understood that various changes, substitutions and alterations can be made herein without departing from the spirit and scope of the disclosure as defined by the appended claims. For example, many of the processes discussed above can be implemented using different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A wavelength division multiplexer/demultiplexer, comprising an optical block having a plurality of protrusions positioned at a first side, and at least one of the protrusions having a first inclined plane configured to reflect a light propagating in the optical block to a second inclined plane of the protrusion.

2. The wavelength division multiplexer/demultiplexer of claim 1, further comprising a first filter positioned at a second side of the optical block, wherein the light is reflected to the first inclined plane by the first filter.

3. The wavelength division multiplexer/demultiplexer of claim 1, further comprising a second filter positioned at a second side of the optical block, wherein the light is reflected to the second filter by the second inclined plane.

4. The wavelength division multiplexer/demultiplexer of claim 1, wherein the first inclined plane is configured to reflect the light in such a way that the light propagates along an optical path having a first included angle larger than 90 degrees at the first inclined plane.

5. The wavelength division multiplexer/demultiplexer of claim 1, wherein the second inclined plane is configured to reflect the light in such a way that the light propagates along an optical path having a second included angle larger than 90 degrees at the second inclined plane.

6. The wavelength division multiplexer/demultiplexer of claim 1, wherein the first inclined plane and the second inclined plane are configured to reflect the light in such a way that the light propagates along an optical path having a trapezoid shape.

7. The wavelength division multiplexer/demultiplexer of claim 1, wherein the first inclined plane is configured to reflect the light to the second inclined plane in such a way that the optical path of the light between the first inclined plane and the second inclined plane is substantially parallel to a side surface of the first side.

8. The wavelength division multiplexer/demultiplexer of claim 1, wherein the optical block has a V-shaped groove between two of the protrusions.

9. The wavelength division multiplexer/demultiplexer of claim 1, wherein the protrusions have different widths.

10. The wavelength division multiplexer/demultiplexer of claim 1, further comprising a reflector covering at least one of the first inclined plane and the second inclined plane.

11. The wavelength division multiplexer/demultiplexer of claim 1, wherein the first inclined plane and the second inclined plane are total reflection planes.

12. The wavelength division multiplexer/demultiplexer of claim 1, wherein the light propagates in the optical block along a first direction as the optical block is used in a multiplexing system, and the light propagates in the optical block along a second direction opposite to the first direction as the optical block is used in a demultiplexing system.

13. The wavelength division multiplexer/demultiplexer of claim 1, wherein the optical block comprises a third inclined plane configured to output the light.

14. The wavelength division multiplexer/demultiplexer of claim 13, further comprising a reflector covering the third inclined plane.

15. The wavelength division multiplexer/demultiplexer of claim 13, wherein the third inclined plane is a total reflection plane.

16. A wavelength division multiplexer/demultiplexer, comprising an optical block having a first side, a plurality of depressions indented from the first side, and at least one of the depressions having a first inclined plane configured to reflect a light to a second side of the optical block and a second inclined plane configured to reflect the light from the second side.

17. The wavelength division multiplexer/demultiplexer of claim 16, further comprising a filter positioned at the second side of the optical block, wherein the light is reflected to the filter by the first inclined plane.

18. The wavelength division multiplexer/demultiplexer of claim 16, further comprising a filter positioned at the second side of the optical block, wherein the light is reflected to the second inclined plane by the filter.

19. The wavelength division multiplexer/demultiplexer of claim 16, wherein the first inclined plane is configured to reflect the light in such a way that the light propagates along an optical path having a first included angle larger than 90 degrees at the first inclined plane.

20. The wavelength division multiplexer/demultiplexer of claim 16, wherein the second inclined plane is configured to reflect the light in such a way that the light propagates along an optical path having a second included angle larger than 90 degrees at the second inclined plane.

21. The wavelength division multiplexer/demultiplexer of claim 16, wherein the first inclined plane and the second inclined plane are configured to reflect the light in such a way that the light propagates along an optical path having a trapezoid shape.

22. The wavelength division multiplexer/demultiplexer of claim 16, wherein the second inclined plane is configured to reflect the light in such a way that the optical path of the light between the first inclined plane and the second inclined plane is substantially parallel to a side surface of the first side.

23. The wavelength division multiplexer/demultiplexer of claim 16, wherein the depressions are V-shaped grooves.

24. The wavelength division multiplexer/demultiplexer of claim 16, further comprising a reflector covering at least one of the first inclined plane and the second inclined plane.

25. The wavelength division multiplexer/demultiplexer of claim 16, wherein the first inclined plane and the second inclined plane are total reflection planes.

26. The wavelength division multiplexer/demultiplexer of claim 16, wherein the depressions are separated by different distances.

27. The wavelength division multiplexer/demultiplexer of claim 16, wherein the light propagates in the optical block along a first direction as the optical block is used in a multiplexing system, and the light propagates in the optical block along a second direction opposite to the first direction as the optical block is used in a demultiplexing system.

28. The wavelength division multiplexer/demultiplexer of claim 16, wherein the optical block comprises a third inclined plane configured to output the light.

29. The wavelength division multiplexer/demultiplexer of claim 28, further comprising a reflector covering the third inclined plane.

30. The wavelength division multiplexer/demultiplexer of claim 28, wherein the third inclined plane is a total reflection plane.
